(19) United States
(12) Patent Application Publication
(10) Pub. No.: US 2018/0315314 A1
(43) Pub. Date: Nov. 1, 2018

(54) AUTOMATED VEHICLE ROUTE TRAVERSAL

(71) Applicant: GM GLOBAL TECHNOLOGY OPERATIONS LLC, Detroit, MI (US)

(72) Inventors: JOSEPH P. GILSENAN, ANN ARBOR, MI (US); DONALD K. GRIMM, UTICA, MI (US); PRAVEEN PALANISAMY, STERLING HEIGHTS, MI (US)

(73) Assignee: GM GLOBAL TECHNOLOGY OPERATIONS LLC, Detroit, MI (US)

(21) Appl. No.: 15/581,900

(22) Filed: Apr. 28, 2017

(51) Int. Cl. G08G 1/16; B60W 30/12; G05D 1/02; B60W 10/20; G01C 21/28; G01C 21/34

(52) U.S. Cl. CPC G08G 1/166; G08G 9/02; G05D 1/0276; B60W 10/20; G01C 21/28; G01C 21/3492; G08G 1/164; B60W 2420/52; B60W 2420/40; B60W 2420/54; B60W 2550/408; B60W 2550/402; B60W 2710/18; B60W 2710/20; B60W 2750/40; B60W 30/12

(57) ABSTRACT

Methods and apparatus are disclosed for providing autonomous driving system functions. The apparatus includes a communication system configured to receive traffic information from an external entity, a guidance system configured to provide guiding signals for guiding a vehicle, and a vehicle control system configured to generate control signals for controlling the vehicle based on the guiding signals. The guidance system is configured to determine a lane guidance signal based on the received traffic information and to instruct the vehicle control system to change a lane of a road having multiple lanes for the same driving direction. The guidance system is configured to map the road by a state machine having individual states representing lanes of a road and longitudinal segments of the road, such that a route of the vehicle is determined as a sequence of states of the state machine.

### TECHNICAL FIELD

The technical field generally relates to autonomous vehicles, and more particularly relates to systems and methods for providing autonomous driving system functions, and yet more particularly relates to determining a lane guidance signal in autonomous vehicle control.

### INTRODUCTION

An autonomous vehicle is a vehicle that is capable of sensing its environment and navigating with little or no user input. An autonomous vehicle senses its environment using one or more sensing devices such as radar, lidar, image sensors, and the like. The autonomous vehicle system further uses information from global positioning systems (GPS) technology, navigation systems, vehicle-to-vehicle communication, vehicle-to-infrastructure technology, and/or drive-by-wire systems to navigate the vehicle.

Vehicle automation has been categorized into numerical levels of automation ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

As part of control of an autonomous vehicle, the conditions, especially the traffic conditions, around a vehicle are sensed and identified, for example to allow control of vehicle speed, steering and adapting a motion path, braking, etc., based on the sensed and identified conditions.

Accordingly, it is desirable to use accurate information about the existing conditions. In addition, it is desirable to enable a long range planning of a moving path of an autonomous vehicle. Furthermore, other desirable features and characteristics of the present invention will become apparent from the subsequent detailed description and the appended claims, taken in conjunction with the accompanying drawings and the foregoing technical field and background.

### SUMMARY

A controller is provided for autonomous driving system functions. The controller includes a communication system configured to receive traffic information from an external entity, a guidance system configured to provide guiding signals for guiding a vehicle, and a vehicle control system configured to generate control signals for controlling the vehicle based on the guiding signals. The guidance system is configured to determine a lane guidance signal based on the received traffic information and to instruct the vehicle control system to change a lane of a road having multiple lanes for the same driving direction. The guidance system is configured to map the road by a state machine having individual states representing lanes of the road and longitudinal segments of the road, such that a route of the vehicle is determined as a sequence of states of the state machine.

In one embodiment, the guidance system is configured to instruct the vehicle control system to change the lane of the road in case of a traffic incident on a current lane of the vehicle.

In another embodiment, the guidance system is configured to instruct the vehicle control system to change the lane of the road near exit locations based on a traffic flow.

In another embodiment, the communication system is configured to receive traffic information from a plurality of external entities, wherein the guidance system is configured to fuse the traffic information from the plurality of external entities, and wherein the guidance system is configured to determine the lane guidance signal based on the fused traffic information.

The external entity may be a remote unit. For example, the external entity may provide traffic information relating to multiple roads and using wireless transmission technique so that any or selected vehicles can receive the traffic information. The external entity may be a stationary traffic information unit. Alternatively or additionally, the external entity may be a mobile unit such as an aircraft (traffic observation helicopter, drone, or the like) or other cars, which provide traffic conditions from their surroundings and sensed by their onboard sensor systems to other cars. For example, multiple vehicles of a fleet of vehicles may upload the sensed traffic conditions from their surroundings to a central traffic information fusing unit which fuses the information and distributes the fused information to all cars from the fleet of vehicles. In one embodiment, the central traffic information fusing unit may be configured to selectively provide only that traffic information to a specific group of cars which are located within a predetermined range of a traffic incident.

In another embodiment, the controller is configured to receive traffic information relating to the traffic conditions in the surroundings of the vehicle from a sensor system onboard the vehicle.

In another embodiment, the guidance system is configured to fuse the traffic information from the external entity and the traffic information from the sensor system.

In another embodiment, the guidance system is configured to partition each of the multiple lanes of the road in longitudinal segments and to assign a route state to each one of the longitudinal segments, wherein the guidance system is configured to additionally consider the route state when determining the lane guidance signal.

In another embodiment, the route state is a weighted route state, wherein the guidance system is configured to weight the route state based on at least one of lane count, traffic flow, traffic incidents, lane congestion, and vehicle density per longitudinal segment.

In another embodiment, the guidance system is configured to determine those longitudinal segments of the road representing an optimal path between a current position of the vehicle and a destination location.

In another embodiment, the optimal path corresponds to those longitudinal segments of the road meeting at least one or a combination of the following criteria when the vehicle drives from the current position to the destination location: minimum time requirement, maximum lane distance between the vehicle and a traffic incident, lowest vehicle density per longitudinal segment.

Unless being indicated as alternatives or referring to another embodiment, any two or more of the embodiments indicated above may be combined with the controller.

A vehicle is provided that includes the controller alone or in combination with one or more of the embodiments described herein.

A method is provided for autonomous driving system functions. In one embodiment, the method includes the steps: receiving traffic information from an external entity, generating control signals for controlling a vehicle based on guiding signals for guiding the vehicle, determining a lane guidance signal based on the received traffic information and by mapping the road by a state machine having individual states representing lanes of a road and longitudinal segments of the road, and determining a route of the vehicle as a sequence of states of the state machine, and instructing a vehicle control system to change a lane of a road in accordance with the determined lane guidance signal.

It is noted that the method may also be modified in accordance with the functions of one or more of the embodiments of the controller described above.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having a controller, in accordance with an embodiment;

FIG. 2 is a functional block diagram illustrating a transportation system having one or more autonomous vehicles of FIG. 1, in accordance with an embodiment;

FIG. 3 is a functional block diagram illustrating a controller, in accordance with an embodiment;

FIG. 4 is a schematic representation of a vehicle, in accordance with an embodiment and embedded within specific traffic conditions;

FIG. 5 is a schematic representation of a route mapping of a controller, in accordance with an embodiment;

FIG. 6 is a schematic representation of a method, in accordance with an embodiment; and

FIG. 7 is a functional block diagram illustrating a vehicle, in accordance with an embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

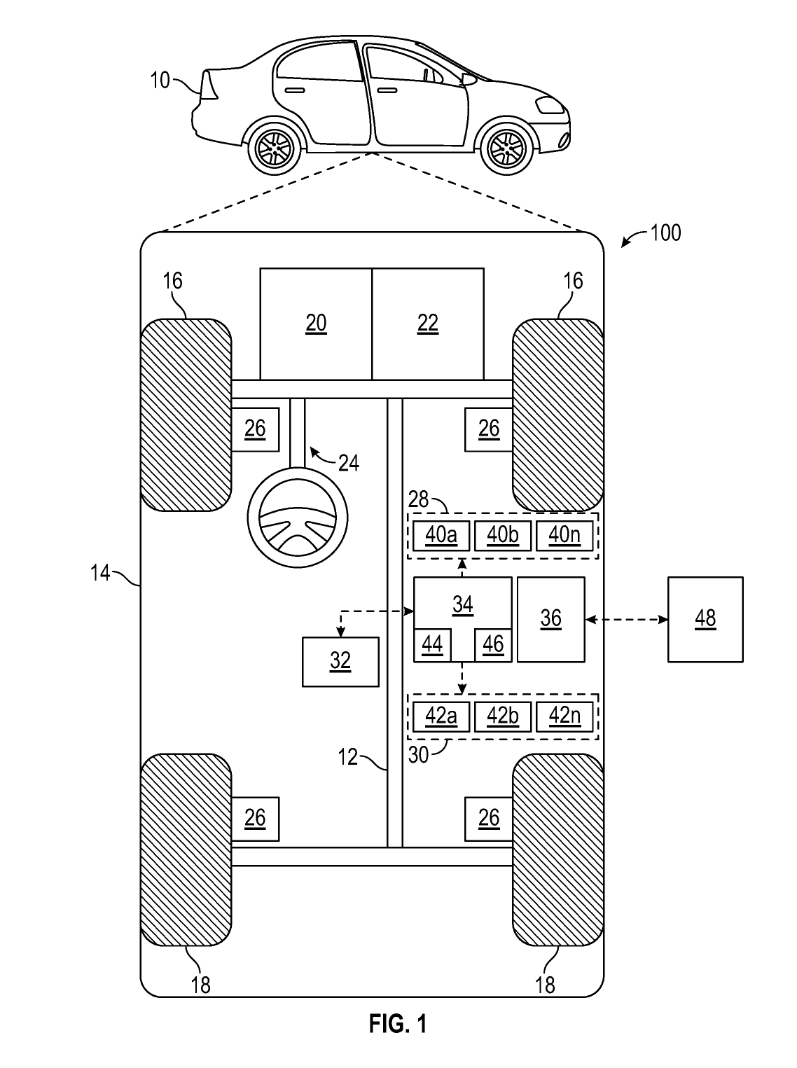

With reference to FIG. 1, a vehicle 10 is shown in accordance with various embodiments. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16 and 18 are each rotationally coupled to the chassis 12 near a respective corner of the body 14.

In various embodiments, the vehicle 10 is an autonomous vehicle. The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16 and 18. The brake system 26 may, in various embodiments, include friction brakes, brake by wire, a regenerative braking system such as an electric machine, and/or other appropriate braking systems. The steering system 24 influences a position of the of the vehicle wheels 16 and 18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

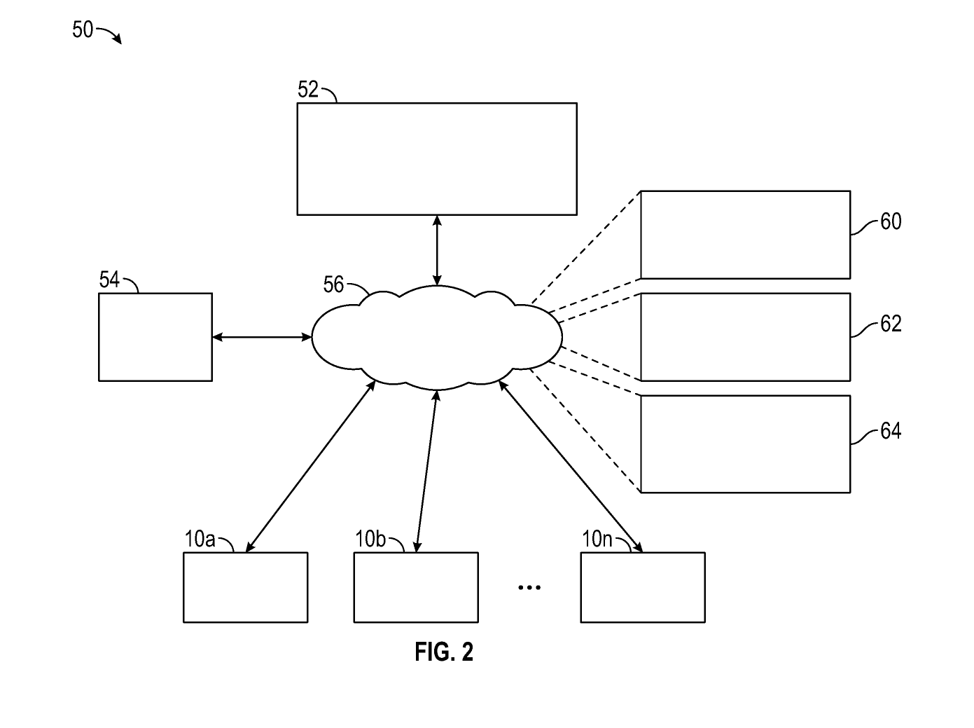

The communication system 36 is configured to wirelessly communicate information to and from other entities 48, such as but not limited to, other vehicles (“V2V” communication) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards. In various embodiments, the communication system 36 is configured to receive traffic information from an external entity 48.

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 34, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the controller 34 are embodied to provide autonomous driving system functions as described with reference to one or more of the embodiments herein. The controller or one of its functional modules is configured to receive traffic information from an external entity. Another or the same functional module of the controller 34 is configured to provide guiding signals for guiding the vehicle 10. Another or the same functional module of the controller 34 is configured to generate control signals for controlling the vehicle 10 based on the guiding signals, wherein this functional module is configured to determine a lane guidance signal based on the received traffic information and to instruct the vehicle 10 to change a lane of a road having multiple lanes for the same driving direction. The controller or one of its functional modules is further configured to map the road by a state machine having individual states representing lanes of a road and longitudinal segments of the road, such that a route of the vehicle is determined as a sequence of states of the state machine.

With reference now to FIG. 2, in various embodiments, the autonomous vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous vehicle based remote transportation system. FIG. 2 illustrates an exemplary embodiment of an operating environment shown generally at 50 that includes an autonomous vehicle based remote transportation system 52 that is associated with one or more autonomous vehicles 10a-10n as described with regard to FIG. 1. In various embodiments, the operating environment 50 further includes one or more user devices 54 that communicate with the autonomous vehicle 10 and/or the remote transportation system 52 via a communication network 56. The communication system 36 is configured to receive traffic information from an external entity or system and to provide the traffic information to the controller 34, in particular to the guidance system 78.

The communication network 56 supports communication as needed between devices, systems, and components supported by the operating environment 50 (e.g., via tangible communication links and/or wireless communication links). For example, the communication network 56 can include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a piece of home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, which may be cloud-based, network-based, or resident at the particular campus or geographical location serviced by the remote transportation system 52. The remote transportation system 52 can be manned by a live advisor, or an automated advisor, or a combination of both. The remote transportation system 52 can communicate with the user devices 54 and the autonomous vehicles 10a-10n to schedule rides, dispatch autonomous vehicles 10a-10n, and the like. In various embodiments, the remote transportation system 52 stores account information such as subscriber authentication information, vehicle identifiers, profile records, behavioral patterns, and other pertinent sub scriber information.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The remote transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

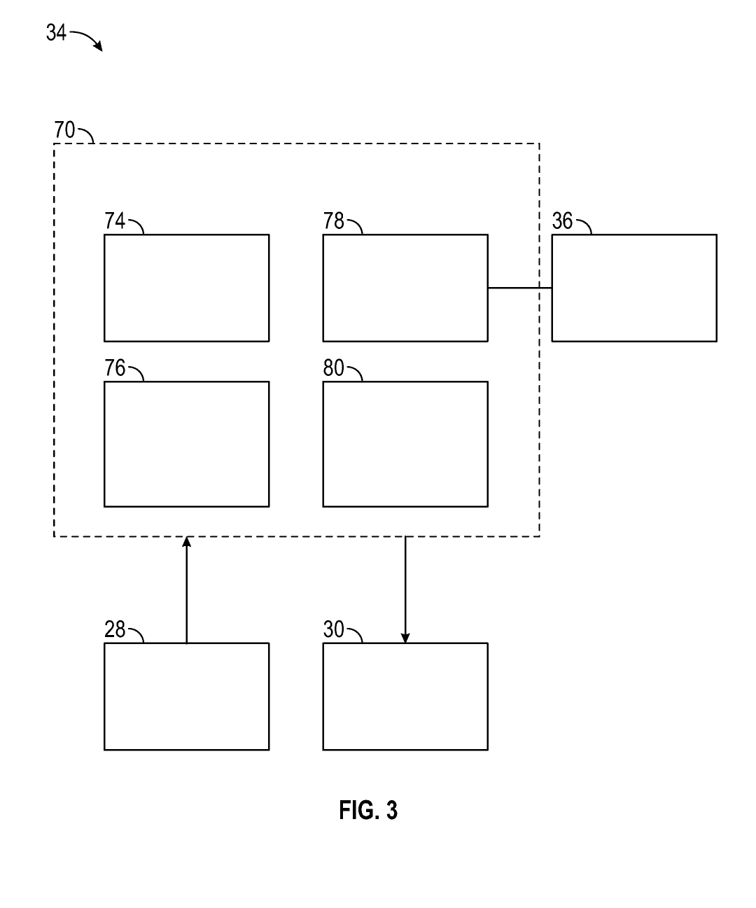

In accordance with various embodiments, controller 34 implements an autonomous driving system (ADS) 70 as shown in FIG. 3. That is, suitable software and/or hardware components of controller 34 (e.g., processor 44 and computer-readable storage device 46) are utilized to provide an autonomous driving system 70 that is used in conjunction with vehicle 10.

In various embodiments, the instructions of the autonomous driving system 70 may be organized by function or system. For example, as shown in FIG. 3, the autonomous driving system 70 can include a sensor fusion system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

The communication system 36 may be part of the controller 34 or may be functionally associated and/or communicatively coupled with the controller 34 and/or with one or multiple of the modules of the autonomous driving system 70.

In various embodiments, the sensor fusion system 74 synthesizes and processes sensor data and predicts the presence, location, classification, and/or path of objects and features of the environment of the vehicle 10. In various embodiments, the sensor fusion system 74 can incorporate information from multiple sensors, including but not limited to cameras, lidars, radars, and/or any number of other types of sensors. The computer vision system 74 may also be referred to as a sensor fusion system, as it fuses input from several sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

The vehicle control system 80 is configured to communicate a vehicle control output to the actuator system 30. In an exemplary embodiment, the actuators 42 include a steering control, a shifter control, a throttle control, and a brake control. The steering control may, for example, control a steering system 24 as illustrated in FIG. 1. The shifter control may, for example, control a transmission system 22 as illustrated in FIG. 1. The throttle control may, for example, control a propulsion system 20 as illustrated in FIG. 1. The brake control may, for example, control wheel brake system 26 as illustrated in FIG. 1.

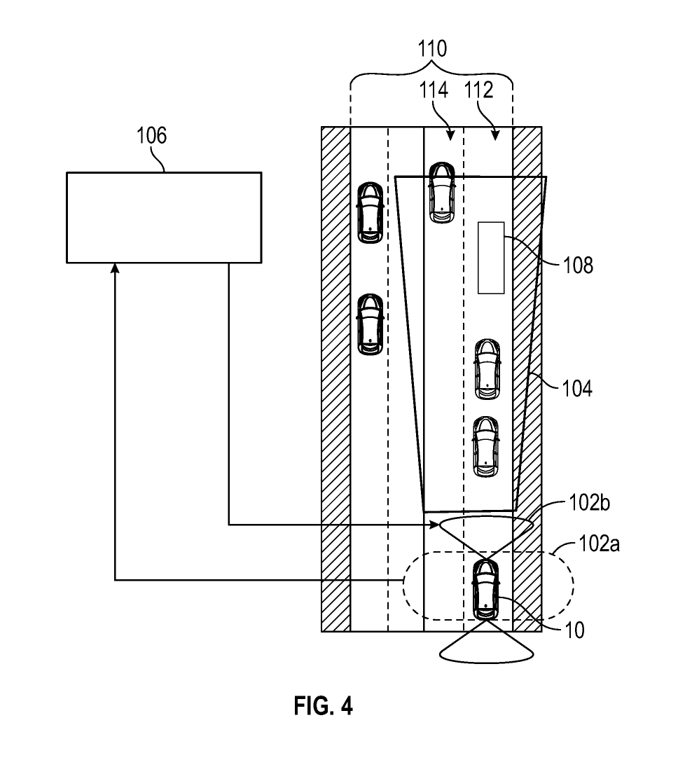

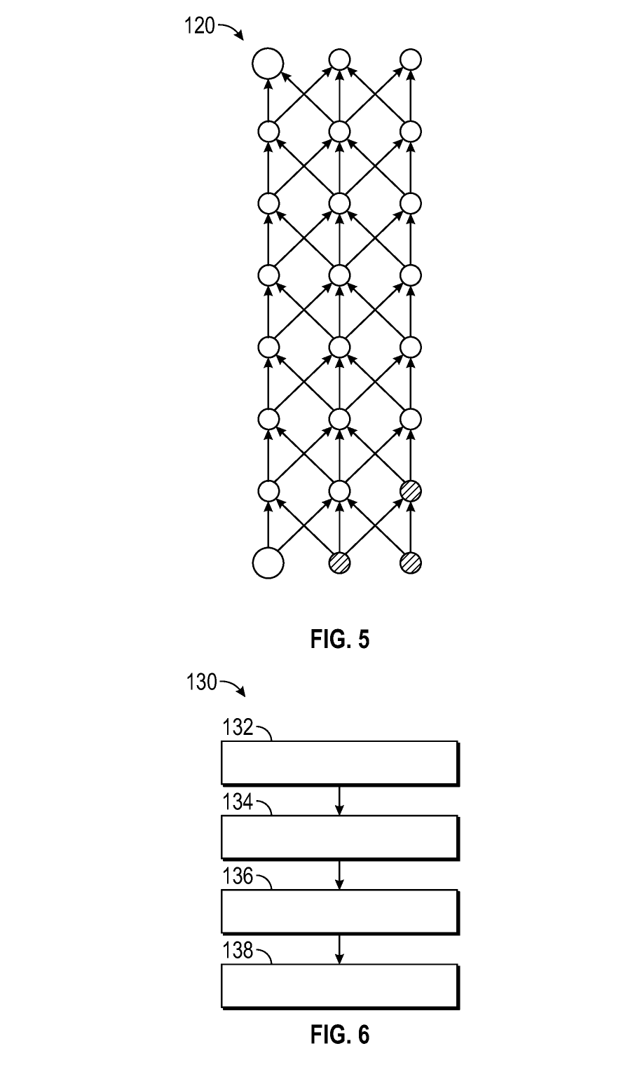

In various embodiments, the guidance system 78 is configured to receive traffic information from the communication system 36. As described above and as described in more detail below, the communication system 36 receives the traffic information from an external entity such as, for example, a traffic data provider 106 (FIG. 4) which may be a stationary unit or from another vehicle. In various embodiments, the communication system 36 is configured to receive traffic information from a plurality of external entities, and the guidance system is configured to fuse the traffic information from the plurality of external entities. In various embodiments, the guidance system is configured to receive traffic information relating to the traffic conditions in the surroundings of the vehicle from the sensor system 28 and/or the positioning system 76. In this embodiment, the guidance system is configured to fuse the traffic information from the external entity and the traffic information from the sensor system. In various embodiments, the guidance system is configured to map the road by a state machine having individual states representing lanes of a road and longitudinal segments of the road, such that a route of the vehicle is determined as a sequence of states of the state machine. This approach is described in more details with reference to FIG. 5.

Based on the traffic information (fused or from a single source), the guidance system 78 is configured to provide guiding signals for guiding the vehicle 10 along a path where the path controls the vehicle 10 to change lanes of a road having multiple lanes in the same driving direction. For example, in various embodiments, the guidance system instructs the vehicle control system to control the vehicle to change the lane of the road in case of a detected traffic incident on a current lane of the vehicle. Alternatively or additionally, in various embodiments, the guidance system instructs the vehicle control system to change the lane of the road near exit locations based on a traffic flow.

Alternatively or additionally, in various embodiments, the guidance system partitions each of the multiple lanes of the road in longitudinal segments and assigns a route state to each one of the longitudinal segments and additionally considers the route state when determining the lane guidance signal. In this embodiment, the route state optionally is a weighted route state, wherein the guidance system weights the route state based on at least one of lane count, traffic flow, traffic incidents, lane congestion, and vehicle density per longitudinal segment. Further, in this embodiment, the guidance system optionally determines those longitudinal segments of the road representing an optimal path between a current position of the vehicle and a destination location. Even further, in this embodiment, the optimal path corresponds to those longitudinal segments of the road meeting at least one or a combination of the following criteria when the vehicle drives from the current position to the destination location: minimum time requirement, maximum lane distance between the vehicle and a traffic incident, lowest vehicle density per longitudinal segment.

FIG. 4 describes a traffic scenario with multiple vehicles 10 on a road 110 having multiple lanes 112, 114 for the same driving direction. In this traffic scenario, the two rightmost lanes are used in a driving direction upwards in the drawing and the two leftmost lanes are used in a driving direction downwards in the drawing. The vehicle 10 collects data from its surrounding, for example about the traffic condition, by using onboard sensors as described above. These onboard sensors have an onboard sensor detection range 102a and 102b, depending on the type of sensor. The detection range of the onboard sensors is directed ahead, backwards, or sidewards with respect to the vehicle 10. However, the detection range of the onboard sensor systems is limited, typically to a visibility range.

The vehicle 10 is configured to receive data from an external entity like the data provider 106. Alternatively or additionally, in various embodiments, the vehicle 10 uploads information about the traffic condition in its vicinity to the data provider 106. The upload and download of data between the data provider 106 and the vehicle 10 is indicated by the arrows in FIG. 4.

In various embodiments, the data provider 106 provides traffic information to the vehicle 10 which relate to a planned route of the vehicle 10, such that a planning horizon 104 of the vehicle 10 is extended due to the availability of data from the traffic data provider 106. As can be seen in FIG. 4, the planning horizon 104 of the vehicle 10 is substantially extended by the external data from the data provider 106. Therefore, information about an obstacle 108 which is invisible for the onboard sensor system of the vehicle 10 are provided to the vehicle by the data provider 106 so that an autonomous driving system of the vehicle 10 initiates a lane change at an early stage.

In various embodiments, the data provider 106 uses wireless communication technology for providing traffic information to the vehicle 10. For example, a mobile communication network is used for this purpose. Vehicle 10 therefore receives external data and local data from the onboard sensors and fuses the external data and the local data in real time in order to determine appropriate instructions for lane change. In the example shown in FIG. 4, the autonomous driving system will receive information from the data provider 106 about an incident on the right lane 112 which will result in a command to move to the left lane 114. The vehicle 10 sends feedback or confirmation commands to the data provider 106. In various embodiments, the vehicle 10 uses historical data about traffic conditions, for example at specific days or times.

FIG. 5 schematically shows an example of a planned route state mapping. In various embodiments, the route state mapping scheme described with reference to FIG. 5 is implemented in a guidance system in accordance with various embodiments described above. A road is mapped by a state machine having individual states representing lanes of a road (these are the vertical columns A, B, and C of the route mapping 120) and longitudinal segments of the road (these are the segments 1 to 8 into which every one of the lanes is divided). A starting position or current position (starting state) of the vehicle is indicated at the bottom left corner with an S. A final position (final state) of the vehicle is indicated at the upper left corner with a G. The remaining states are chosen for the route of the vehicle depending on the respective traffic condition.

Each planned route is divided into a state machine 120 with individual states selected based on lane count, location, maneuvers, etc. Adjacent states are connected via edges, each representing the maneuver required to transition from one state to another. When new data is received or the vehicle's current state has changed, a score for each one of the states is recalculated and the state machine is updated. Due to the effect that at adjacent states have on one another, score updates occur in a breadth-first manner emanating from both the vehicle's current state within the planned route and any states whose score has changed above a predetermined threshold. Based on the calculated scores of the states, the autonomous driving system determines a state-traversal path which minimizes the amount of required driver intervention. This state-traversal path is determined such that vehicle 10 runs around incidents or longitudinal segments of a lane where an incident happened. In other words, lane shift recommendations are provided based on the determined state-traversal path.

For example, in case of an incident in the longitudinal segment between states A5 and A4 causing heavy traffic in the longitudinal segments between A5 and A6 and possibly between A6 and A7, an early lane shift as follows guides the vehicle 10 in an advantageous manner around the incident: A8-B7-C6-C5-C4-B3-A2-A1. Thus, an early lane shift may avoid the vehicle 10 getting caught in heavy traffic in longitudinal segments of lane A as a result of the incident between A5 and A4. Furthermore, such an early lane shift may avoid a lane shift in heavy traffic, which may be undesired for an autonomous vehicle.

Similar considerations may apply to lane shift ahead of exits or intersections. An autonomous vehicle planning to turn right the next intersection may use the rightmost lane. However, in case of an incident ahead of the intersection, the vehicle may need to change to the left lane to drive around the incident. It may be desired that this lane change to the left is done before the autonomous vehicle is being caught in heavy traffic on the right lane. Traffic information from the external entity or data provider 106 may help initiating a lane change of an autonomous vehicle at an early stage. With the onboard sensor system, a vehicle cannot sense a traffic jam or a road incident until the incident the zone comes into the field of view of the onboard sensor system. In contrast thereto, when using traffic data from the external data provider 106, the autonomous vehicle may initiate a lane change at a greater distance from the road incident. Based on these external data (and additionally based on information from other sources like the onboard sensor system and historical data), a path plan of the autonomous vehicle may be updated.

The score of a state may be determined based on real time traffic data which may contain information about traffic incidents, traffic flow, and information from other vehicles. The real time traffic data may be obtained from traffic information provider or services and/or from other vehicles via an inter-vehicle communication protocol, like V2X. Furthermore, when determining the score of a state, also predicted traffic data like traffic flow may be considered. The predicted traffic data may base on weather information, date and time, historic data, sun angle, etc.

Based on these real time traffic data and predicted traffic data, a global state, a traffic state, and a local state may be estimated. The global state estimation may relate to impending route-required states and to impending adjacent states not on planned route. The traffic state estimation may relate to traffic data related to upcoming route states and to instantaneous current traffic state. The local state estimation may relate to a local state within planned route (current lane level), valid adjacent states, and current vehicle parameters. These parameters and data are fused to obtain a state score for each state of the route. For example, for each state a score will be calculated via the fusing of data from real time data sources, historic data sources, and scores of adjacent states.

FIG. 6 shows a schematic flow chart 130 indicating the steps of a method in accordance with one embodiment. In a first step 132, traffic information is received from an external entity. Subsequently, in a second step 134, control signals for controlling a vehicle are generated based on guiding signals for guiding the vehicle. In a third step 136, a lane guidance signal is determined based on the received traffic information and the road is mapped by a state machine having individual states representing lanes of the road and longitudinal segments of the road, and determining a route of the vehicle as a sequence of states of the state machine. In a fourth step 138, a vehicle control system is instructed to change a lane of a road in accordance with the determined lane guidance signal.

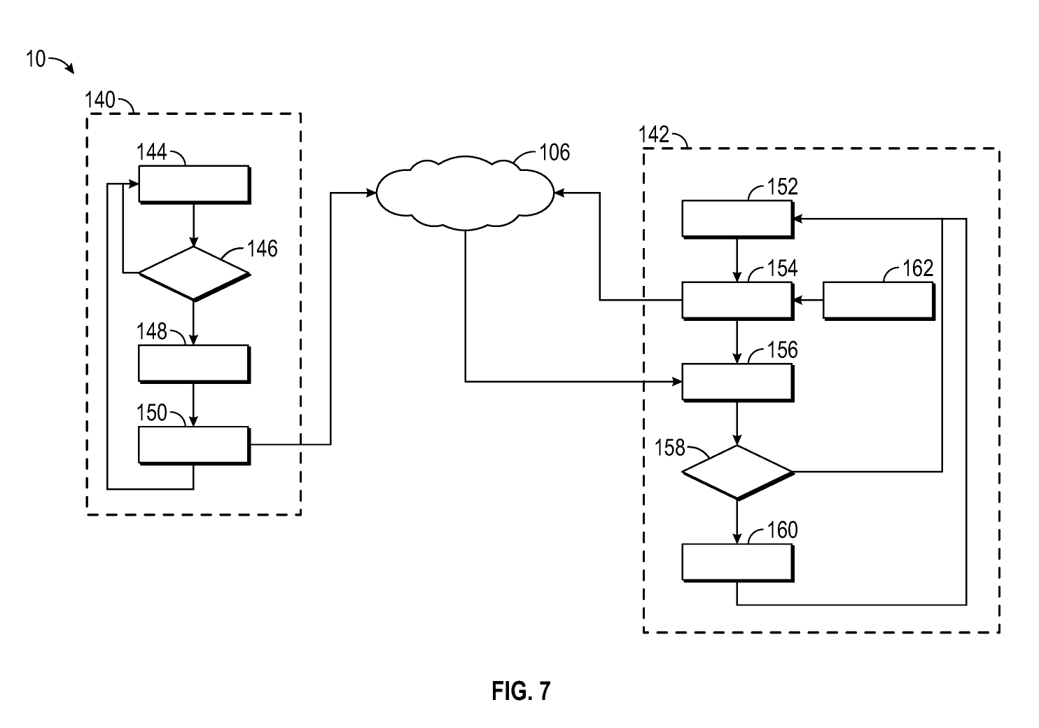

FIG. 7 schematically illustrates a functional block diagram of a vehicle 10 in accordance with an embodiment. Basically, the functions of the vehicle 10 are assigned to an advisor system 142 or to a feedback system 140, each of which is indicated by dashed lines. In the following, with the functions of the advisor system and the feedback system will be described without the intention to bind these functions to a structural component. These functions may be implemented within and/or may be part of the controller 34 described above with reference to other embodiments.

Traffic information is provided by traffic providers or data providers 106 and may contain information about incidents, traffic flow rate, and the like. Data from the data provider 106 may be queried by a query function 154 and the data provider 106 will provide, in response to this query, traffic data to advisor system which fuses the received data in a fusing function 156. An advice determining function 158 will determine if an action or a maneuver is advisable. If so, the maneuver may be executed by a maneuver function 160. Otherwise, the advisor system 142 will again and iteratively acquire the geographic location of the vehicle with acquiring function 152 and will again query information from data provider 106, so that police functions are repeated in an iterative manner. A customization function 162 enables a user of the vehicle to customize the functions of the advisor system 142 by providing appropriate menu settings.

The feedback system 140 includes a vehicle parameters monitoring function 144, which especially monitors and captures the traffic conditions in the surroundings of the vehicle. The vehicle parameters monitoring function 144 may utilize the onboard sensor system of the vehicle for this purpose. The monitoring function 144 provides its output to a maneuver function 146 which determines an appropriate maneuver responsive to the captured traffic conditions. Such a maneuver may be the command “change to the left lane” if there is an incident on the right lane. A save parameter function 148 saves the parameters and a submit function 150 submits the vehicle's view of an incident to the data provider 106 so that information about the detected incident may be provided to other vehicles.

In other words, a vehicle may be a data consumer (the advisor system 142 receives data from the data provider 106) as well as a data generator or data provider (the feedback system 140 uploads information about traffic incidents detected by the vehicle).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A controller providing autonomous driving system functions, comprising:
a communication system configured to receive traffic information from an external entity;
a guidance system configured to provide guiding signals for guiding a vehicle;
a vehicle control system configured to generate control signals for controlling the vehicle based on the guiding signals;
wherein the guidance system is configured to determine a lane guidance signal based on the received traffic information and to instruct the vehicle control system to change a lane of a road having multiple lanes for the same driving direction;
wherein the guidance system is configured to map the road by a state machine having individual states representing lanes of the road and longitudinal segments of the road, such that a route of the vehicle is determined as a sequence of states of the state machine.

2. The controller of claim 1,
wherein the guidance system is configured to instruct the vehicle control system to change the lane of the road in case of a traffic incident on a current lane of the vehicle.

3. The controller of claim 1,
wherein the guidance system is configured to instruct the vehicle control system to change the lane of the road near exit locations based on a traffic flow.

4. The controller of claim 1,
wherein the communication system is configured to receive traffic information from a plurality of external entities;
wherein the guidance system is configured to fuse the traffic information from the plurality of external entities;
wherein the guidance system is configured to determine the lane guidance signal based on the fused traffic information.

5. The controller of claim 1,
wherein the controller is configured to receive traffic information relating to the traffic conditions in the surroundings of the vehicle from a sensor system onboard the vehicle.

6. The controller of claim 5,
wherein the guidance system is configured to fuse the traffic information from the external entity and the traffic information from the sensor system.

7. The controller of claim 1,
wherein the guidance system is configured to partition each of the multiple lanes of the road in longitudinal segments and to assign a route state to each one of the longitudinal segments;
wherein the guidance system is configured to additionally consider the route state when determining the lane guidance signal.

8. The controller of claim 7,
wherein the route state is a weighted route state;
wherein the guidance system is configured to weight the route state based on at least one of lane count, traffic flow, traffic incidents, lane congestion, and vehicle density per longitudinal segment.

9. The controller of claim 8,
wherein the guidance system is configured to determine those longitudinal segments of the road representing an optimal path between a current position of the vehicle and a destination location.

10. The controller of claim 9,
wherein the optimal path corresponds to those longitudinal segments of the road meeting at least one or a combination of the following criteria when the vehicle drives from the current position to the destination location: minimum time requirement, maximum lane distance between the vehicle and a traffic incident, lowest vehicle density per longitudinal segment.

11. A vehicle with a controller configured to provide autonomous driving system functions, the controller comprising:
a communication system configured to receive traffic information from an external entity;
a guidance system configured to provide guiding signals for guiding the vehicle;
a vehicle control system configured to generate control signals for controlling the vehicle based on the guiding signals;
wherein the guidance system is configured to determine a lane guidance signal based on the received traffic information and to instruct the vehicle control system to change a lane of a road having multiple lanes for the same driving direction;
wherein the guidance system is configured to map the road by a state machine having individual states representing lanes of the road and longitudinal segments of the road, such that a route of the vehicle is determined as a sequence of states of the state machine.

12. The vehicle of claim 11,
wherein the guidance system is configured to instruct the vehicle control system to change the lane of the road in case of a traffic incident on a current lane of the vehicle.

13. The vehicle of claim 11,
wherein the guidance system is configured to instruct the vehicle control system to change the lane of the road near exit locations based on a traffic flow.

14. The vehicle of claim 11,
wherein the communication system is configured to receive traffic information from a plurality of external entities;
wherein the guidance system is configured to fuse the traffic information from the plurality of external entities;
wherein the guidance system is configured to determine the lane guidance signal based on the fused traffic information.

15. The vehicle of claim 11, further comprising:
an onboard sensor system;
wherein the controller is configured to receive traffic information relating to the traffic conditions in the surroundings of the vehicle from the onboard sensor system.

16. The vehicle of claim 15,
wherein the communication system is configured to upload the traffic information received from the onboard sensor system to the external entity.

17. The vehicle of claim 15,
wherein the guidance system is configured to fuse the traffic information from the external entity and the traffic information from the onboard sensor system.

18. The vehicle of claim 11,
wherein the guidance system is configured to partition each of the multiple lanes of the road in longitudinal segments and to assign a route state to each one of the longitudinal segments;
wherein the guidance system is configured to additionally consider the route state when determining the lane guidance signal;
wherein the route state is a weighted route state;
wherein the guidance system is configured to weight the route state based on at least one of lane count, traffic flow, traffic incidents, lane congestion, and vehicle density per longitudinal segment.

19. The vehicle of claim 18,
wherein the guidance system is configured to determine those longitudinal segments of the road representing an optimal path between a current position of the vehicle and a destination location;
wherein the optimal path corresponds to those longitudinal segments of the road meeting at least one or a combination of the following criteria when the vehicle drives from the current position to the destination location: minimum time requirement, maximum lane distance between the vehicle and a traffic incident, lowest vehicle density per longitudinal segment.

20. A method for providing autonomous driving system functions, comprising the steps:
receiving traffic information from an external entity;
generating control signals for controlling a vehicle based on guiding signals for guiding the vehicle;
determining a lane guidance signal based on the received traffic information and by mapping the road by a state machine having individual states representing lanes of the road and longitudinal segments of the road, and determining a route of the vehicle as a sequence of states of the state machine; and
instructing a vehicle control system to change a lane of a road in accordance with the determined lane guidance signal.
